(19) United States
(12) Patent Application Publication
(10) Pub. No.: US 2011/0186388 A1
(43) Pub. Date: Aug. 4, 2011

(54) FALL ARREST DEVICE

(76) Inventors: Robert Adam Sudale, Coventry West Midlands (GB); Robert Hirst, Birmingham (GB)

(21) Appl. No.: 12/737,979

(22) PCT Filed: Sep. 3, 2009
(86) PCT No.: PCT/EP2009/061426

§ 371 Date: Apr. 11, 2011

(30) Foreign Application Priority Data
Sep. 6, 2008 (GB) 0816343.8

(51) Int. Cl. A62B 1/14

(52) U.S. Cl. 188/65.2

(57) ABSTRACT

A fall arrest device has an upright use position and an inverted position. The fall arrest device comprises a body (1) including means providing a curved region (3) defining a path through the device for a track. The fall arrest device also comprises anti-inversion means (19, 43) comprising a housing (21, 45) provided on the body adjacent to the path. The housing includes an aperture (23) formed through the housing and a pin (25, 57) slidably mounted in the aperture. The arrangement is such that the pin slides into the housing when the fall arrest device is in the upright position, but slides outwardly from the housing when the fall arrest device is in the inverted position so as to block the path through the device.

This invention relates to a fall arrest device, and more particularly relates to a fall arrest device which incorporates means to prevent a user installing the device upside down.

Fall arrest devices which are mountable on tracks, such as cables, and which serve to arrest the fall of a user are well known. Such devices generally incorporate a cam which is moved to engage with the track in the event of a fall. One problem with such cams is that they are generally effective only when the device is mounted on the track in a correct orientation and are not effective if the device is mounted upside down on the track.

It is known to provide means for preventing a user installing a fall arrest device upside down. For example, JP-A-200655301 provides a rotatable member which engages with a locking plate in the event the device is inverted to prevent movement of a locking member. U.S. Pat. No. 5,638,919 provides a pin which prevents the fall arrest device being successfully mounted on the track. However, a problem associated with both such devices is that inversion of the fall arrest device after it has been mounted on the track will prevent removal of the device from the track.

It is therefore an object of the present invention to provide a fall arrest device incorporating means to prevent a user installing the device upside down and which overcomes, or at least ameliorates, the problem described above.

According to the present invention there is provided a fall arrest device having an upright use position and an inverted position, the fall arrest device comprising: a body including means providing a curved region defining a path through the device for a track; and anti-inversion means comprising a housing provided on the body adjacent to the path, the housing including an aperture formed through the housing and a pin slidably mounted in the aperture whereby the pin slides into the housing when the fall arrest device is in the upright position, but slides outwardly from the housing when the fall arrest device is in the inverted position so as to block the path through the device.

The housing may be secured to the body and the aperture may be angled such that the pin slides into the housing under the influence of gravity when the fall arrest device is in the upright position, but slides outwardly from the housing under the influence of gravity when the fall arrest device is in the inverted position so as to block the path through the device.

The housing may be formed integrally with the body, or it may be formed as a separate component and secured to the body.

The aperture may be at an angle in the range from about 30 degrees to about 75 degrees, preferably about 30 degrees, to the vertical when the device is in the inverted position.

The pin may be offset from a centre of the path towards a free edge of the curved region of the body.

Alternatively, the housing may be pivotably mounted on the body.

Protrusions may be provided on the body to restrict pivoting movement of the housing.

The housing may comprise an arm which is pivotably mounted at one end thereof and is provided with a tubular member at the other end thereof in which the pin is received.

The pin may be formed with an enlarged head at that side of the tubular member adjacent to the curved portion of the body.

The fall arrest device may additionally include secondary anti-inversion means.

The secondary anti-inversion means may comprise a housing located adjacent to a guide block for the track which is pivotably mounted on the housing, the housing including an aperture formed therethrough and a pin slidably mounted in the housing, the aperture being angled such that the pin slides into the housing under the influence of gravity when the fall arrest device is in the upright position, but slides outwardly from the housing under the influence of gravity when the fall arrest device is in an inverted position so as to engage with the guide block and inhibit pivoting thereof.

The housing of the secondary anti-inversion means may be formed integrally with the body, or it may be formed as a separate component and secured to the body.

The aperture through the housing of the secondary anti-inversion means may be at an angle in the range from about 30 degrees to about 75 degrees, preferably about 30 degrees, to the vertical when the device is in the inverted position.

The pin of the secondary anti-inversion means may be stepped so as to prevent a head portion thereof passing through the housing. The aperture may also be stepped to receive the head portion of the pin. A free end of the pin may be enlarged to prevent the pin being removed from the aperture.

The guide block may be formed with an aperture or a recess for receiving the pin, the aperture or recess being substantially aligned with the pin when the fall arrest device is not in use.

Alternatively, the secondary anti-inversion means may comprise a flap which is pivotally mounted within the fall arrest device to block movement of a cam member in a direction away from the path when the fall arrest device is in the inverted position. The flap may pivot under the influence of gravity. Movement of the flap, for example to the blocking position, may be constrained by a pin extending from the body of the fall arrest device. Movement of the flap, for example to an inactive position, may be constrained by a projection provided on the housing of the primary anti-inversion means.

For a better understanding of the present invention and to show more clearly how it may be carried into effect reference will now be made, by way of example, to the accompanying drawings in which:

FIG. 1 is a side view of one embodiment of a fall arrest device incorporating anti-inversion means according to the present invention, a cover of the fall arrest device being removed for clarity;

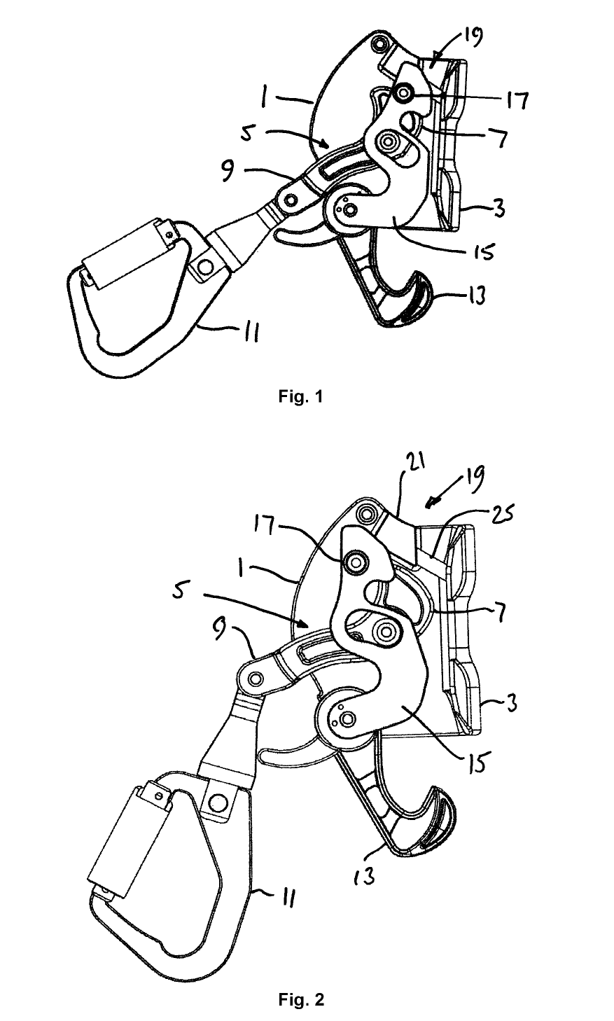

FIG. 2 is a view corresponding to FIG. 1, but with a locking plate retracted to show more detail of the anti-inversion means;

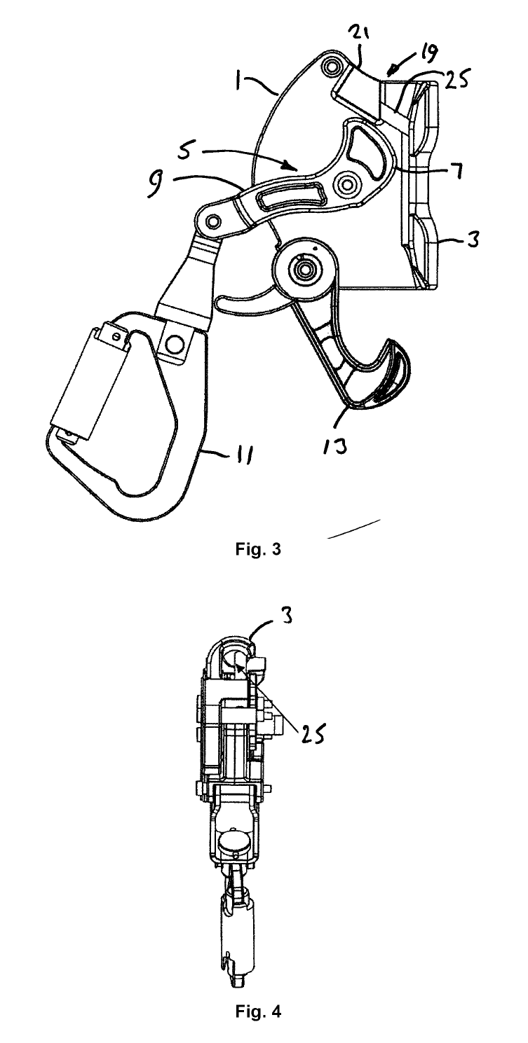

FIG. 3 is a further view corresponding to FIG. 2, but with the locking plate removed;

FIG. 4 is an end view of the fall arrest device showing the anti-inversion means in operation;

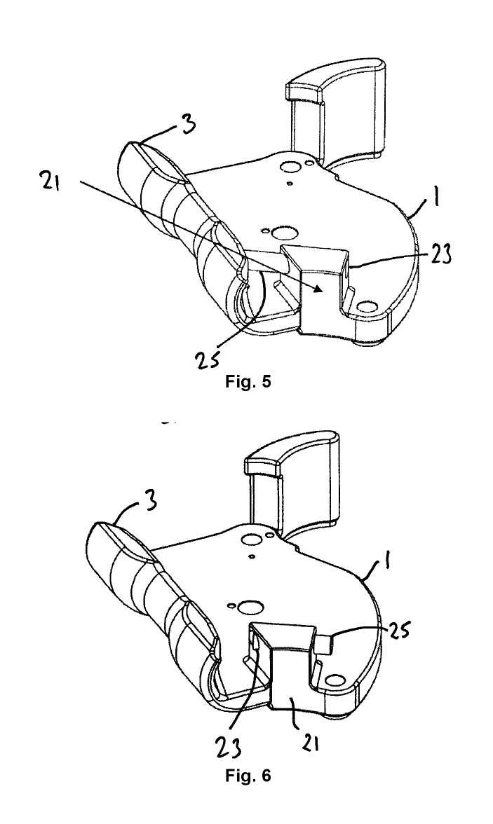

FIG. 5 is a perspective view of a part of the fall arrest device showing the anti-inversion means in a first configuration;

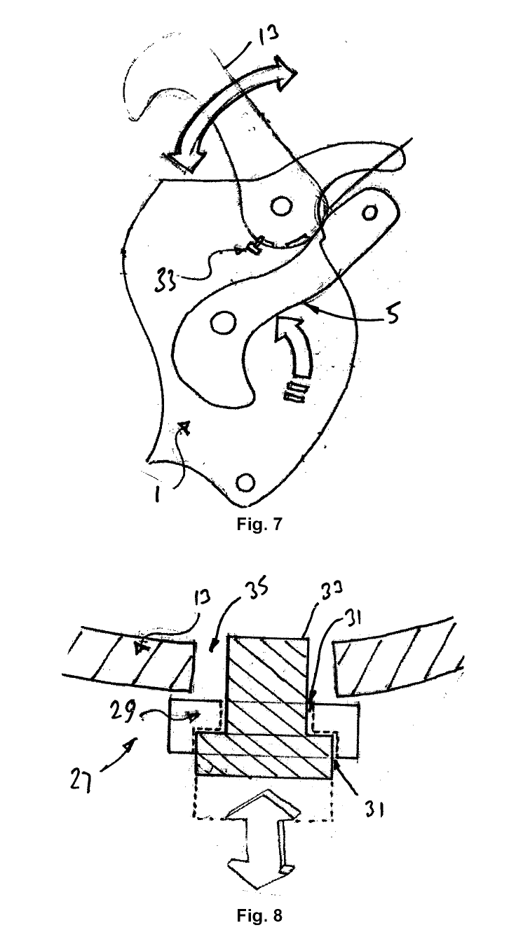

FIG. 6 is a perspective view corresponding to FIG. 5, but with the anti-inversion means in a second configuration;

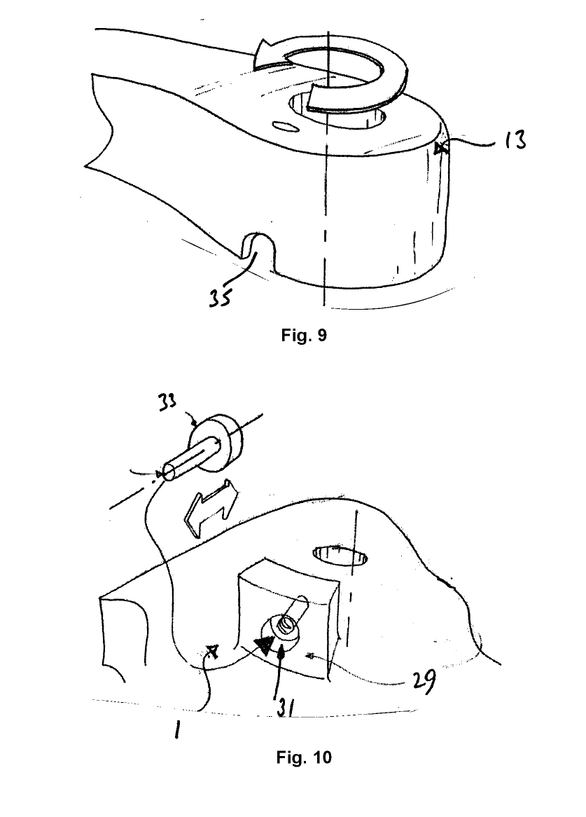

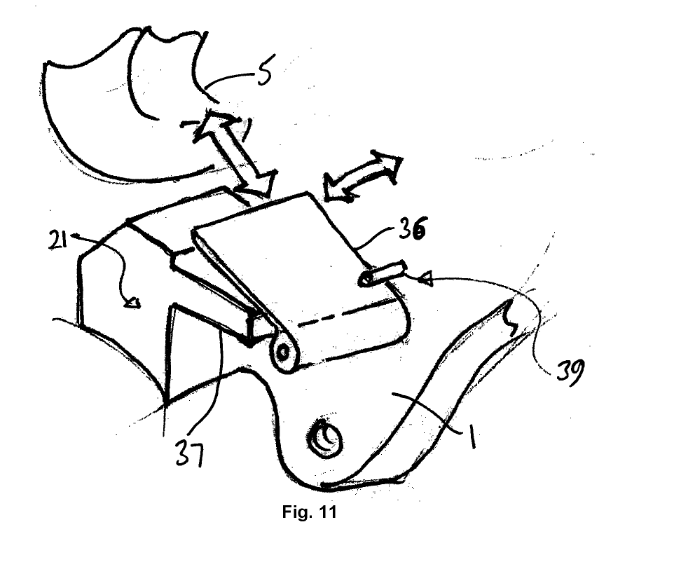

FIGS. 7 to 10 show a secondary anti-inversion device for use with the anti-inversion device shown in FIGS. 1 to 6;

FIG. 11 is a diagrammatic illustration of an alternative form of secondary anti-inversion device;

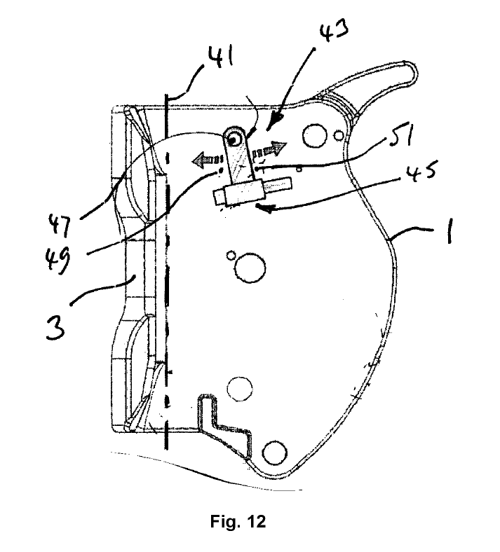

FIG. 12 is a side view of another embodiment of a fall arrest device incorporating anti-inversion means according to the present invention, with various components of the fall arrest device being removed for clarity, the fall arrest device being in a first orientation;

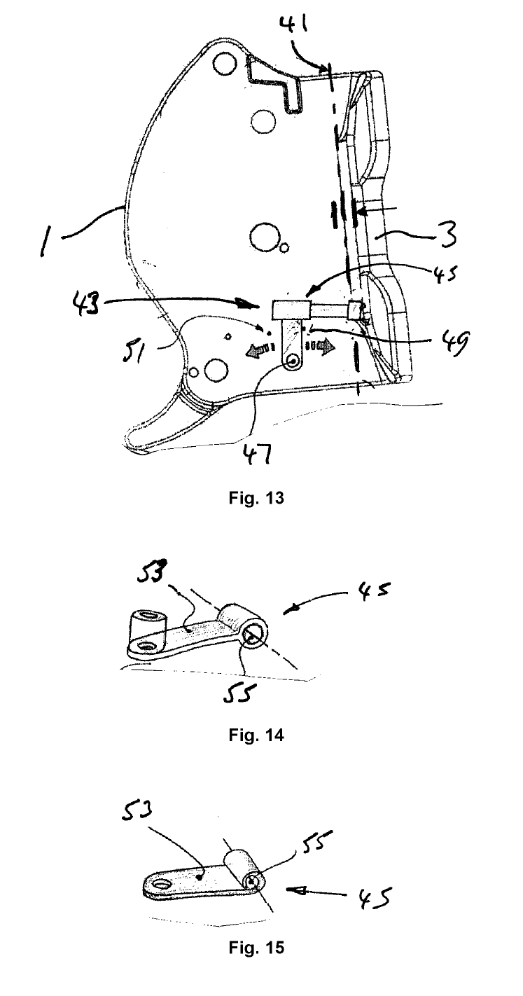

FIG. 13 is a view corresponding to FIG. 12, the fall arrest device being in a second orientation;

FIG. 14 is a perspective view of one embodiment of a component of the anti-inversion means shown in FIG. 12;

FIG. 15 is a perspective view of another embodiment of the component of the anti-inversion means shown in FIG. 12; and

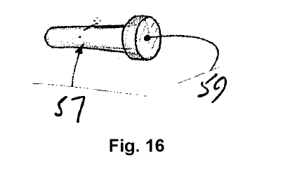

FIG. 16 is a perspective view of another component of the anti-inversion means shown in FIG. 12.

FIGS. 1 to 6 show a fall arrest device which includes a body 1 which is formed with a curved edge region 3 defining a path for a track through the device. In practice, the device includes a cover plate which is not shown for reasons of clarity. A cam member 5 is pivotably mounted on the body 1 and includes a cam 7 which is movable towards and away from the path formed within the curved edge region 3 and an operating lever 9 with a karabiner 11 mounted at a free end of the operating lever. A guide block 13 is pivotally mounted at an upper region (in use) of the body and includes a free end which is adapted to contact the track so as to inhibit undesired rotation of the fall arrest device relative to the track. It should be noted that the fall arrest device is shown in an inverted orientation in FIGS. 1 to 3 to illustrate an anti-inversion device which will be explained in detail hereinafter.

The track is retained within the path defined by the curved edge region 3 by means of a locking plate 15 which is pivotally co-mounted with the guide block 13. The locking plate 15 has an edge which, in use, is located adjacent to a free edge of the curved edge region 3 so as to retain the track within the fall arrest device. However, on releasing a locking pin 17, the locking plate can be pivoted away from the free edge to allow the fall arrest device to be mounted on, or removed from, the track.

An anti-inversion device 19 is mounted on the body 1, for example in an upper region of the body as shown in FIGS. 1 to 3 (note this would be in a lower region of the body in normal use of the fall arrest device). The anti-inversion device comprises a housing 21 which may be cast integrally with the body 1 or may be formed as a separate component and secured to the body 1. In either case, the housing 21 does not move relative to the body 1. The housing is located adjacent to the path and has a cylindrical aperture 23 which extends through the housing at a predetermined downwardly inclined angle such that an anti-inversion pin 25 will slide in a downwards direction towards the path of the track through the device when the device is inverted. For example the aperture and therefore the anti-inversion pin may be at an angle in a range from about 30 to about 75 degrees to the vertical, preferably at substantially 60 degrees to the vertical, when the device is inverted. To minimise friction, the cylindrical aperture 23 may be reamed and the pin 25 may be made of stainless steel with a smooth ground or smooth polished finish.

Thus, when the fall arrest device is inverted the pin 25 will slide out from the housing 21 towards the path of the track through the device under the influence of gravity so as to block the path and prevent the device being mounted on the track, while, when the device is in the correct orientation, the pin 25 will slide back into the housing under the influence of gravity and leave the path open to enable the device to be mounted on the track. The fall arrest device will in practice include further components which will prevent the pin 25 sliding entirely through the housing 21, thus allowing the pin to be a simple cylinder. FIG. 5 shows the pin 25 in a position so as to block the path, while FIG. 6 shows the pin in a position in which it does not block the path. As can be seen from FIG. 4, it is convenient for the pin 25 to be offset from the centre of the path through the device towards the free edge of the curved edge region 3 so as to minimise the extent to which the track can be moved towards the path.

Thus there is no interaction between the pin 25 and any other moving component of the fall arrest device.

FIGS. 7 to 10 show a secondary anti-inversion device 27 which operates independently of the anti-inversion device 19 and which may be provided to increase anti-inversion security.

The secondary anti-inversion device comprises a housing 29 which is formed with a stepped cylindrical aperture 31, the aperture having a greater diameter in that region thereof remote from a component to be locked in an inverted orientation of the fall arrest device. The housing may be cast integrally with the body 1 of the device or may be secured thereto. A locking pin 33 is slidably mounted in the housing 29 and is also stepped with a larger diameter region thereof remote from a component to be locked in an inverted orientation of the fall arrest device. The larger diameter region of the pin 33 is dimensioned to fit within the larger diameter region of the aperture 31 in the housing 29, but not to pass through the smaller diameter region thereof. The free end of the smaller diameter region of the pin 33 is peened to increase the diameter of the pin at its very end and to prevent the pin being removed from the aperture 31. It should be noted that it is not essential that the aperture 31 is stepped: as an alternative the larger diameter region of the pin 33 can bear against the outside of the housing 29. The aperture 31 is angled such that the locking pin 33 moves under the influence of gravity when the fall arrest device is moved between its upright and inverted position. For example, the aperture may be at an angle in the range from about 30 degrees to about 75 degrees, preferably about 30 degrees, to the vertical when the fall arrest device is in the inverted position.

The housing 29 is positioned adjacent to the guide block 13 which in use contacts the track. The guide block is pivotable between a rest position in which it effectively blocks the path of the track, and an in-use position in which a free end of the guide block bears against the track but, of course, does not obstruct the path of the track. The guide block 13 is provided with an aperture 35 (or alternatively a recess) designed to accommodate the smaller diameter region of the pin 33 and which is axially aligned with the pin in the rest position of the guide block.

In use of the secondary anti-inversion device, when the fall arrest device is in its normal use orientation the pin 33 falls under the influence of gravity so as to leave a clearance between the end of the pin and the guide block 13. In this configuration the device can be mounted onto the track. However, with the fall arrest device in an inverted configuration and the guide block in its rest position, the free end of the pin 33 enters the aperture 35 to inhibit rotation of the guide block away from its rest position until such time as the fall arrest device is moved to its normal use orientation.

While there is with the secondary anti-inversion device interaction between the locking pin 33 and a movable component of the fall arrest device in the form of the guide block 13, the interaction can only take place prior to the device being mounted on the track and cannot arise once the device is on the track.

FIG. 11 shows an alternative secondary anti-inversion device which operates independently of the anti-inversion device 19. The device shown in FIG. 11 comprises a flap 36 which is pivotally mounted on the body 1, the extent of pivoting being constrained by a protrusion 37 formed on the housing 21 of the anti-inversion device and by a pin 39 extending from the body 1. When the fall arrest device is in the correct use orientation the pivotal flap 36 rests under gravity against the protrusion 37, but when the fall arrest device is inverted the flap pivots under the influence of gravity to bear against the pin 39 and in this position blocks movement of the cam member 5 in a direction which would move the cam 7 away from the path through the fall arrest device. In this way, the fall arrest device cannot be opened sufficiently to mount the device on the track.

The fall arrest device shown in FIGS. 12 to 16 is a modification of that shown in FIGS. 1 to 6 and the same references are used to denote the same or similar components. The secondary anti-inversion devices of FIGS. 7 to 10 or FIG. 11 may be used with the fall arrest device of FIGS. 12 to 16.

The fall arrest device of FIGS. 12 to 16 comprises a body 1 which is formed with a curved region 3 defining a path 41 for a track or cable through the device. Further components, such as a cover, cam member, cam, operating lever, karabiner and others have been omitted from this embodiment for clarity. The fall arrest device is shown in an upright (in use) orientation in FIG. 12 and in an inverted orientation in FIG. 13.

An anti-inversion device 43 is mounted in an upper region of the body 1 in normal use of the device and comprises a housing 45 which is mounted to the body by way of a pivot pin 47 and which can pivot back and forth through an angle which is restricted by two protrusions 49, 51 provided on the body 1. The housing 45 is shown in more detail in FIG. 14 and comprises an arm 53 at the free end of which a tubular member 55 is provided. The protrusions 49, 51 maintain the arm 53 extending generally in the direction of the path 41 through the fall arrest device. An alternative form of the housing 45 is shown in FIG. 15. A pin 57, shown in more detail in FIG. 16, is slidably mounted within the tubular member of the housing and is formed with an enlarged head 59. The pin 57 and the interior of the tubular member 55 are smoothed and polished to ensure the pin can slide freely within the tubular member.

In use of the anti-inversion device shown in FIGS. 12 to 16, with the fall arrest device in its upright orientation, The head 59 of the pin 57 lies at a level below the pivot pin 47 and the pivot range of the housing 45 is such that the head of the pin slides towards the tubular member 55 and away from the curved portion 3 of the body 1. When the anti-inversion device is used with the fall arrest device in an inverted orientation, the weight of the head 59 of the pin 57 is sufficient to cause the housing 45 to pivot to contact the protrusion 49 and in this orientation the axis of the pin is angled to the horizontal such that the pin slides out of the tubular member 45 towards the curved portion 3 of the body 1 so as to prevent the fall arrest device being mounted on the track. The head of the pin contacts the curved portion before the pin slides entirely out of the tubular member.

1. A fall arrest device having an upright use position and an inverted position, the fall arrest device comprising: a body (1) including means providing a curved region (3) defining a path through the device for a track; and anti-inversion means (19, 43) comprising a housing (21, 45) provided on the body adjacent to the path, the housing including an aperture (23) formed through the housing and a pin (25, 57) slidably mounted in the aperture whereby the pin slides into the housing when the fall arrest device is in the upright position, but slides outwardly from the housing when the fall arrest device is in the inverted position so as to block the path through the device.

2. A device as claimed in claim 1, wherein the housing (21) is secured to the body (1) and the aperture (23) is angled such that the pin (25) slides into the housing under the influence of gravity when the fall arrest device is in the upright position, but slides outwardly from the housing under the influence of gravity when the fall arrest device is in the inverted position so as to block the path through the device.

3. A device as claimed in claim 1, wherein the housing (21) is formed integrally with the body (1).

4. A device as claimed in claim 1, wherein the housing (21) is formed as a separate component and secured to the body (1).

5. A device as claimed in claim 1, wherein the aperture (23) is at an angle of about 30 degrees to about 75 degrees to the vertical when the device is in the inverted position.

6. A device as claimed in claim 1, wherein the aperture (23) is at an angle of about 30 degrees to the vertical when the device is in the inverted position.

7. A device as claimed in claim 1, wherein the pin (25) is offset from a centre of the path towards a free edge of the curved region (3) of the body (1).

8. A device as claimed in claim 1, wherein the housing (45) is pivotably mounted on the body (1).

9. A device as claimed in claim 8, wherein protrusions (49, 51) are provided on the body to restrict pivoting movement of the housing (45).

10. A device as claimed in claim 8, wherein the housing (45) comprises an arm (53) which is pivotably mounted at one end thereof and is provided with a tubular member (55) at the other end thereof in which the pin (57) is received.

11. A device as claimed in claim 8, wherein the pin (57) is formed with an enlarged head (59) at that side of the tubular member (55) adjacent to the curved portion (3) of the body (1).

12. A device as claimed in claim 1 and including secondary anti-inversion means (27, 36).

13. A device as claimed in claim 12, wherein the secondary anti-inversion means (27) comprises a housing (29) located adjacent to a guide block (13) for the track which is pivotably mounted on the housing, the housing including an aperture (31) formed therethrough a pin (33) slidably mounted in the housing, the aperture being angled such that the pin slides into the housing under the influence of gravity when the fall arrest device is in the upright position, but slides outwardly from the housing under the influence of gravity when the fall arrest device is in an inverted position so as to engage with the guide block and inhibit pivoting thereof.

14. A device as claimed in claim 13, wherein the housing (29) of the secondary anti-inversion means (27) is formed integrally with the body (1).

15. A device as claimed in claim 13, wherein the housing (29) of the secondary anti-inversion means (27) is formed as a separate component and secured to the body (1).

16. A device as claimed in claim 13, wherein the aperture (31) through the housing (29) of the secondary anti-inversion means (27) is at an angle in the range from about 30 degrees to about 75 degrees to the vertical when the device is in the inverted position.

17. A device as claimed in claim 16, wherein the aperture (31) through the housing (29) of the secondary anti-inversion means (27) is at an angle of about 30 degrees to the vertical when the device is in the inverted position.

18. A device as claimed in claim 13, wherein the pin (33) of the secondary anti-inversion means (27) is stepped so as to prevent a head portion thereof passing through the housing (29).

19. A device as claimed in claim 18, wherein the aperture (31) is also stepped to receive the head portion of the pin (33).

20. A device as claimed in claim 18, wherein the free end of the pin (33) is enlarged to prevent the pin being removed from the aperture (31).

21. A device as claimed in claim 13, wherein the guide block (13) is formed with an aperture (35) or a recess for receiving the pin (33), the aperture or recess being substantially aligned with the pin when the fall arrest device is not in use.

22. A device as claimed in claim 12, wherein the secondary anti-inversion means comprises a flap (36) which is pivotally mounted within the fall arrest device to block movement of a cam member (5) in a direction away from the path when the fall arrest device is in the inverted position.

23. A device as claimed in claim 22, wherein the flap (36) pivots under the influence of gravity.

24. A device as claimed in claim 22, wherein movement of the flap (36) is constrained by a pin (39) extending from the body (1) of the fall arrest device.

25. A device as claimed in claim 22, wherein movement of the flap (36) is constrained by a projection (37) provided on the housing (21) of the primary anti-inversion means (19).
